(19) United States
(12) Patent Application Publication
(10) Pub. No.: US 2005/0193178 A1
(43) Pub. Date: Sep. 1, 2005

(54) Systems and methods for flexible extension of SAS expander ports

(76) Inventors: William Voorhees, Colorado Springs, CO (US); Carl Gygi, Colorado Springs, CO (US)

Correspondence Address: LSI LOGIC CORPORATION, 1621 BARBER LANE, MS: D-106, MILPITAS, CA, 95035, US

(21) Appl. No.: 10/788,590

(22) Filed: Feb. 27, 2004

(51) Int. Cl. G06F 12/00

(52) U.S. Cl. 711/149

(57) ABSTRACT

A multi-chip module (MCM) designed using standard die SAS expander components for rapidly designing a customized SAS expander having a predetermined number of ports. A number of standard expander die circuit components are selected and disposed on a MCM design. Each expander die circuit has a predetermined number of internal ports within the MCM and a predetermined number of ports for coupling to SAS devices external to the MCM. An internal fabric is disposed on the MCM and selectively coupled to internal ports of the SAS expanders to provide the desired number of external ports with desired routing therebetween. The internal fabric may be statically configured or dynamically programmed. The internal fabric routing may provide wide port routes as well as standard port connections.

### BACKGROUND OF THE INVENTION

1. Field of the Invention

The invention generally relates to configuring ports of a storage domain. More specifically, the invention relates to flexibly configuring ports within a Serial Attached Small Computer Systems Interface (“SAS”) domain component to operate according to application requirements.

2. Discussion of Related Art

Small Computer Systems Interface (“SCSI”) is a set of American National Standards Institute (“ANSI”) standard electronic interface specification that allow, for example, computers to communicate with peripheral hardware. Common SCSI compatible peripheral devices may include: disk drives, tape drives, Compact Disc-Read Only Memory (“CD-ROM”) drives, printers and scanners. SCSI as originally created included both a command/response data structure specification and an interface and protocol standard for a parallel bus structure for attachment of devices. SCSI has evolved from exclusively parallel interfaces to include both parallel and serial interfaces. “SCSI” is now generally understood as referring either to the communication transport media (parallel bus structures and various serial transports) or to a plurality of primary commands common to most devices and command sets to meet the needs of specific device types as well as a variety of interface standards and protocols.

The collection of primary commands and other command sets may be used with SCSI parallel interfaces as well as with serial interfaces. The serial interface transport media standards that support SCSI command processing include: Fibre Channel, Serial Bus Protocol (used with the Institute of Electrical and Electronics Engineers 1394 FireWire physical protocol; “IEEE 1394”) and the Serial Storage Protocol (SSP).

SCSI interface transports and commands are also used to interconnect networks of storage devices with processing devices. For example, serial SCSI transport media and protocols such as Serial Attached SCSI (“SAS”) and Serial Advanced Technology Attachment (“SATA”) may be used in such networks. These applications are often referred to as storage networks. Those skilled in the art are familiar with SAS and SATA standards as well as other SCSI related specifications and standards. Information about such interfaces and commands is generally obtainable at the website http://www.t10.org.

Such SCSI storage networks are often used in large storage systems having a plurality of disk drives to store data for organizations and/or businesses. The network architecture allows storage devices to be physically dispersed in an enterprise while continuing to directly support SCSI commands directly. This architecture allows for distribution of the storage components in an enterprise without the need for added overhead in converting storage requests from SCSI commands into other network commands and then back into lower level SCSI storage related commands.

A SAS network typically comprises one or more SAS initiators coupled to one or more SAS targets via one or more SAS expander devices. In general, as is common in all SCSI communications, SAS initiators initiate communications with SAS targets. The expander devices expand the number of ports of a SAS network domain used to interconnect SAS initiators and SAS targets (collectively referred to as SAS devices).

In designing a SAS expander device, it is common for a designer to create a design for a fixed number of expander ports. A variety of design points may be created such that a different number of ports is available in different product designs. However, changing a design to incorporate a greater or lesser number of ports may present numerous difficulties and associated costs to the designer. Increasing the number of ports in an existing design by a significant number may not be as simple as merely scaling parameters of a particular design.

In view of the above discussion, it is evident that there is a need for improved systems and methods for flexibly re-designing and re-configuring an expander design to alter design points thereof such as the number of ports within the expander.

### SUMMARY OF THE INVENTION

The present invention solves the above and other problems, thereby advancing the state of useful arts, by providing methods and associated structures to permit flexible re-design of an expander to alter the number of ports in the expander design thus more easily generating a customized expander design. In one aspect hereof, existing individual expander components are provided as standard circuit designs and coupled in a multi-chip module (“MCM”) to a static internal fabric. Connections between ports of the multiple expander components in the MCM determine the static routes defined within the customized router. The number of ports in the MCM customized expander may be easily adapted by adding or removing expander components coupled to the internal fabric of the MCM. The internal fabric may then easily route one port to another within the MCM. Such an internal fabric may comprise fixed wires or other conductive paths through the MCM. The addition or subtraction of individual expander components within the MCM allows for simple re-design of an expander to accommodate virtually any desired number of ports. The internal fabric allows the customized ports to be configured with static routes in virtually any desired configuration.

A first feature hereof therefore provides a multi-chip module (MCM) comprising: a plurality of SAS expander component circuits each having a number (n) of internal ports internal to the MCM and each having a number (m) of external ports for coupling to SAS devices external to the MCM; and an internal fabric coupling selected ones of the internal ports in selected ones of the plurality of SAS expander component circuits.

Another aspect hereof further provides that the internal fabric comprises a static fabric.

Another aspect hereof further provides that the static fabric is configured at manufacture of the MCM.

Another aspect hereof further provides that the static fabric is configured at reset of the MCM.

Another aspect hereof further provides for a control logic circuit to configure the static fabric at reset of the MCM.

Another aspect hereof further provides that the internal fabric comprises a programmable fabric.

Another aspect hereof further provides that the programmable fabric is adapted to be configured by information received from a SAS device coupled to an external port of a SAS expander of the MCM.

Another aspect hereof further provides for coordination logic communicatively coupled to the plurality of SAS expander component circuits to coordinate operation of the plurality of SAS expander component circuits.

Another aspect hereof further provides that the coordination logic is adapted to present a unified expander to devices outside the module.

Another aspect hereof further provides that the coordination logic is adapted to coordinate SMP message processing logic within each expander of the plurality of SAS expander component circuits.

Another aspect hereof further provides that the coordination logic is adapted to present a single SAS address for the plurality of SAS expander component circuits.

Another aspect hereof further provides that the coordination logic is adapted to present a single set of PHY numbers for the PHYs of the plurality of SAS expander component circuits.

### BRIEF DESCRIPTION OF THE DRAWINGS

FIG. 1 is a block diagram of a SAS expander customized in accordance with presently known techniques and structures.

FIG. 2 is a block diagram of an improved customized SAS expander designed and fabricated using MCM structures and techniques in accordance with features and aspects hereof.

FIG. 3 is a block diagram providing additional details of the improved MCM expander in accordance with features and aspects hereof.

FIG. 4 is a flowchart of methods for design of an improved MCM expander in accordance with features and aspects hereof.

FIG. 5 is a diagram showing exemplary interconnections through an internal fabric of an MCM expander in accordance with features and aspects hereof

### DETAILED DESCRIPTION OF THE DRAWINGS

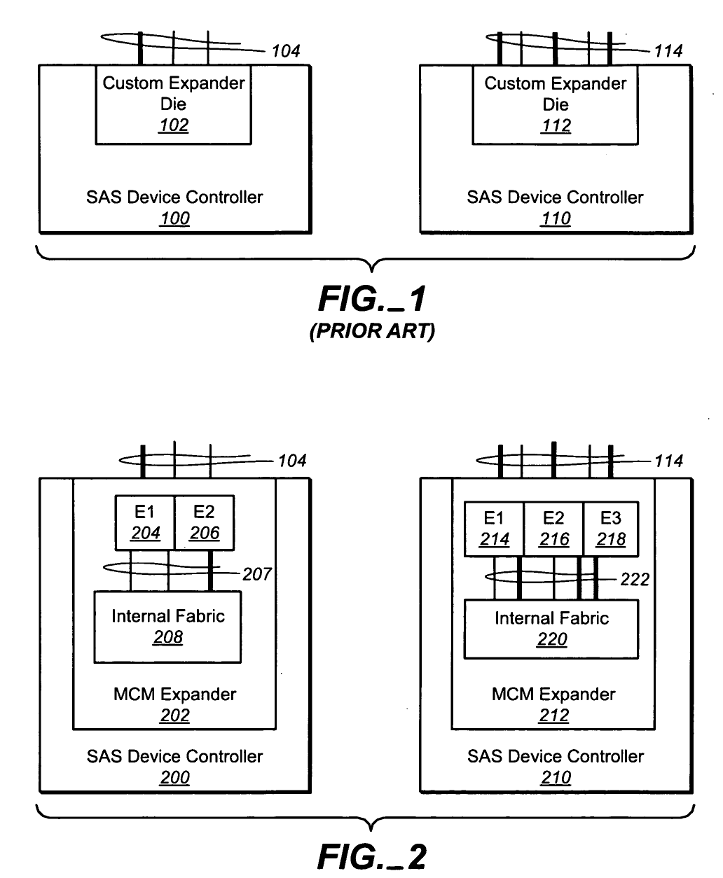

FIG. 1 shows a typical SAS expander 100 having an integral custom expander circuit die 102 embedded within. Custom expander circuit die 102 is designed by an appropriate engineer to provide, for example, three ports adapted for coupling to SAS devices outside SAS expander 100. Ports 104 are exemplified by two thinner lines representing standard ports and one thicker line representing a wide port configuration as generally known in the SAS specifications. SAS device controller 110 is a similar SAS controller including a custom expander circuit die 112 providing external ports 114—two standard ports represented by thinner lines and three wide ports represented by thicker lines. As noted above, presently known techniques may require a significant redesign effort to modify custom expander circuit die 112 to provide additional ports 114. Full custom circuit design and fabrication can be complex and costly.

By way of contrast with FIG. 1, FIG. 2 shows MCM expanders 202 and 212 within SAS expanders 200 and 210, respectively. MCM expander 202, for example, is designed to provide the same compliment of external ports 104 as does the custom expander circuit die 102 of FIG. 1. However, MCM expander 202 uses MCM design components and methods to more easily design and fabricate an appropriate custom expander design. Though an initial design may be as complicated or even more complicated in some respects than the task of designing a full custom circuit/expander, the customization of subsequent design points adding or subtracting ports or reconfiguring various paths for wide port exchanges is dramatically simplified by use of MCM design components and methodologies. In like manner, MCM expander 212 provides additional external ports 114 as does custom expander circuit die 112 of FIG. 1 but also does so utilizing MCM components and design methods.

In particular, exemplary MCM expander 202 includes standard expander component E1 204 and E2 206 coupled through internal fabric 208 via internal ports 207. The use of such standard expander components to provide a particular desired number of internal ports 207 and external ports 104 simplifies design and fabrication of expander 202 as compared to a full custom expander circuit die 102 as in FIG. 1. In like manner, MCM expander 212 includes standard expander components E1 214, E2 216 and E3 218 all coupled through internal fabric 222 to thereby provide the desired number of external ports 114 and internal ports 222.

Each standard expander component (i.e., 204, 206, 214, 216 and 218), may include any number of internal and external ports. Each standard expander component may be identical providing an identical number of such internal and external ports or, as a matter of design choice, a variety of standard expander components may each provide a particular number of the internal and or external ports may be utilized. Each expander component may be described as having a number m of external ports and a number n of internal ports. Further, any number N of such standard expander components, each providing any number of internal or external ports, may be combined within an MCM expander structure.

Those skilled in the art will recognize that the particular number and arrangement of internal ports and external ports in the exemplary MCM expanders 202 and 212 of FIG. 2 are merely intended as suggestive of the particular configurations that may be provided in accordance with features and aspects hereof. Numerous other configurations will be readily apparent to those of ordinary skill in the art.

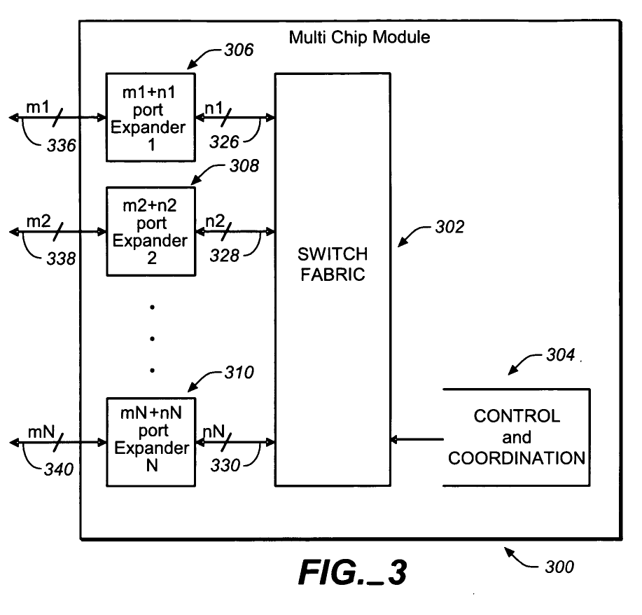

FIG. 3 is a diagram providing additional details of a typical MCM expander 300 adapted to provide features and aspects hereof. The MCM expander 300 includes one or more standard expander components 306 through 310 disposed therein. Any number of such standard expander components may be provided within multi-chip module expander 300. Each standard expander component 1 through N may provide a predetermined number of external ports m and a predetermined number of internal ports n. For example, standard expander component 1 (306) provides a number of external ports m₁ (336) and a standard number of internal ports n₁ (326). Standard expander component 2 (308) provides m₂ external ports (338) and n₂ internal ports (328). Standard expander component N (310) provides m_{N} external ports (340) and n_{N} internal ports (330). As noted above, external ports 336, 338 and 340 are used by MCM expander 300 to couple to SAS devices external to MCM expander 300. Internal ports 306, 308 and 310 couple the standard expander components within MCM expander 300 to internal switch fabric 302 also within MCM expander 300. Switched fabric 302 provides internal routes and paths between the various standard expander components 306, 308 and 310 within MCM expander 300. For example, external ports 336 associated with standard port expander 1 (306) may be coupled by internal ports 326 through switch fabric 302 and an internal port 330 to standard port expander component N 310 and then to a corresponding external port thereof 340. Any number of such connected pathways may be provided through switch fabric 302 and the various internal ports (326, 328 and 330) of the standard expander components 306, 308 and 310, respectively.

As noted above, each standard expander component 306, 308 and 310 within MCM expander 300 may provide any desired number of external and internal ports. In particular, a variety of standard expander components may be readily available to a designer such that any desired configuration of total external ports and corresponding total internal ports may be created by appropriately selecting a collection of such standard expander components. In addition, other features and aspects hereof may provide that each standard expander port provide an identical number of external and/or internal ports. Those of ordinary skill in the art will recognize that a wide variety of standard expander components may be provided to enhance the flexibility of configuring any desired MCM expander structure 300.

Internal switch fabric 302 may comprise static conductive paths interconnecting selected ones of the internal ports 326, 328 and 330 of the various standard expander components 306, 308 and 310, respectively. Such a static collection of conductive paths may provide a static configuration of internal pathways within the MCM expander 300 determined at manufacturing or fabrication time of the MCM expander 300. Such static conductive paths may be disposed on the MCM expander 300 by well known wiring or other deposition and etching processes. Such design and fabrication techniques for MCM modules are generally known to those of ordinary skill in the art.

Other aspects hereof provide that internal switch fabric 302 may be dynamically programmed to provide switchable conductive paths between internal ports of the various standard expander components within MCM expander 300. In such a case, control and coordination element 304 provides desired switch control selection for paths between the various internal ports of the standard expander components. Control and coordination element 304 may therefore comprise programmed or programmable logic for coupling internal ports of the standard port expanders through internal switch fabric 302. The program logic within control and coordination element 304 may therefore provide a static configuration for coupling of internal ports of standard expander components within MCM expander 300 such that the static configuration is established at reset of the MCM expander 300 rather than at time of manufacture. Alterations in the program logic of control and coordination element 304 may provide a different static configuration set of the MCM expander 300.

Still further aspects hereof allow for control and coordination element 304 to be dynamically programmed in accordance with information received through an external port of MCM expander 300. A predetermined selected port of the various external ports provided (e.g., 336, 338 and 340) may be adapted to receive program information to be applied through switch fabric 302 to control and coordination element 304. The received program information within control and coordination element 304 may then be applied to switch fabric 302 to selectively couple desired internal ports of the standard expander components.

Control and configuration element 304 may be further operable to coordinate operation of the multiple standard expander components 306, 308 and 310. Such coordination may include, for example, coordination of the standard expanders to present a single, unified expander interface to devices external to the MCM expander 300. More specifically, the coordination may include presenting a single SAS address for the entire MCM expander 300, presenting a single set of PHY numbers for the multiple PHYs provided by the MCM expander 300, and processing all SMP functionality through the single set of PHYs as if the PHYs and SMP processing are within a single expander device. The coordination features of control and coordination element 304 may be provided as custom logic circuits coupled to each of the standard expander components 306-310 or as programmed or programmable logic within element 304.

Specific design tools, methodologies and fabrication techniques for multi-chip modules are generally known to those of ordinary skill in the art. Automated design tools as well as manual design and fabrication procedures may be employed as known to those of ordinary skill in the art. Further, those of ordinary skill in the art will recognize a variety of programming techniques for statically configuring internal switch fabric 302 at time of manufacture, for programmably configuring a static configuration of internal switch fabric 302 at reset of MCM expander 300, and for dynamically reconfiguring internal switch fabric 302 in response to program information received on a predetermined external port of MCM expander 300. Numerous well known logic structures including programmable logic structures may be employed within control and coordination element 304 and selected as well known design choices for those of ordinary skill in the art.

Further aspects hereof permit internal ports 326, 328 and 330 of standard port expanders 306, 308 and 310, respectively, to be configured as standard, single-width internal ports or as aggregations of multiple ports to utilize as wide ports in accordance with SAS specifications. As generally known to those skilled in the art, a plurality of single port internal ports may be aggregated and operated in a cooperative, synchronized manner to provide features of a SAS wide port. The static or dynamic configuration of internal switch fabric 302 may therefore provide selectable conductive pathways for standard SAS ports as well as wide SAS ports by appropriately coupling internal ports of the various standard expander components. So configuring wide port conductive paths through internal switch fabric 302 permits external ports of the standard expander components to be dynamically configured as wide ports in accordance with requirements of a particular application of MCM expander 300.

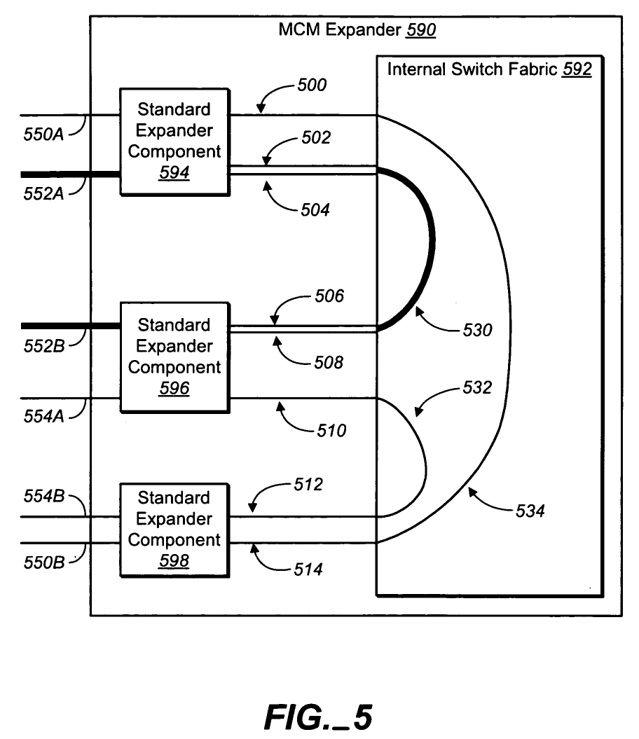

FIG. 5 is a diagram describing an exemplary static configuration of internal switch fabric 592 within an MCM expander 590. The exemplary configuration of FIG. 5 is intended merely to aid the reader in understanding one possible application of features and aspects hereof. MCM expander 590 may include three standard expander components of 594, 596 and 598. Standard expander components 594 and 596 each provide three internal ports (internal ports 500, 502 and 504 provided by expander component 594 and internal ports 506, 508 and 510 provided by expander component 596). Standard expander component 598 provides six internal ports (512 through 522).

In an exemplary application of such an MCM expander 590, internal ports 502 and 504 may be aggregated to provide a wide port in accordance with SAS specifications. Similarly, internal ports 506, 508 and 516, 518 and 520, 522 may be aggregated to provide higher bandwidth wide ports in accordance with SAS specifications. The double wide port defined by the aggregation of internal ports 502 and 504 and the wide port defined by the aggregation of internal ports 506 and 508 are coupled together within internal switch fabric 592 by wide path 530 (the wide path indicated by the thicker line). Standard internal port 500 is coupled via path 534 to standard internal port 514 and standard internal port 510 is coupled via path 532 to standard internal port 512.

This exemplary coupling of internal ports within internal switch fabric 592 permits an exemplary configuration and utilization of external ports provided by the standard expander components 594 through 598 of MCM expander 590. In the exemplary configuration of FIG. 5, external port 550A may exchange information through corresponding external port 550B. Wide external port 552A may exchange information through wide external port 552B. External port 554A may exchange information with external port 554B.

Those of ordinary skill in the art will recognize a wide variety of methods and structures for configuring the internal couplings shown within internal switch fabric 592. As noted above, such configurations may be statically configured either at time of manufacture or at reset of the MCM expander 590. Further, other aspects hereof provide that the configuration of internal switch fabric 592 may be dynamically performed in accordance with programmable logic the (as discussed above and not shown in FIG. 5). In addition, those skilled in the art will recognize that wide port configurations may aggregate various numbers of internal ports to provide desired bandwidth. Performance requirements of a particular application of MCM expander 590 will determine (in part) the appropriate configuration of standard and wide ports.

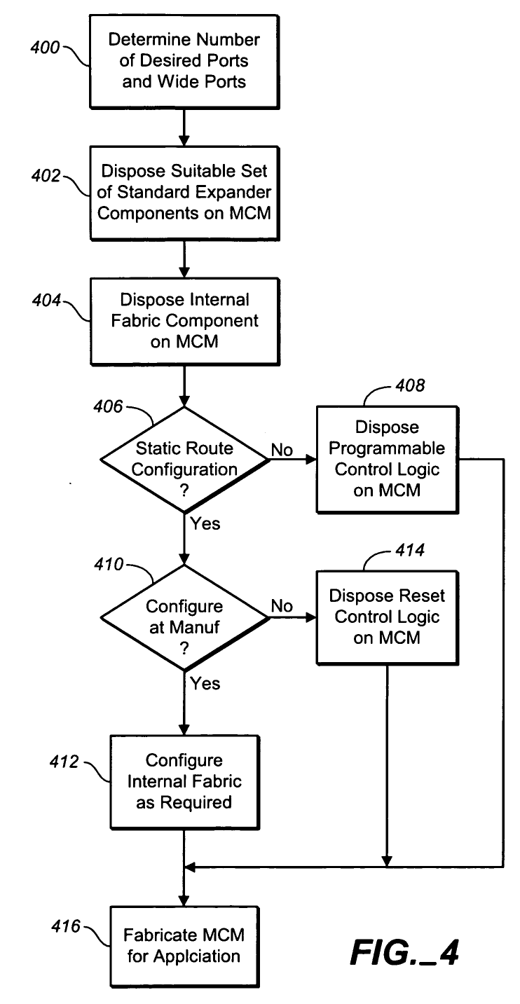

FIG. 4 s a flowchart describing a method of design and fabrication for an MCM customized expander in accordance with features and aspects hereof. Element 400 is first operable to determine a desired number of ports and wide ports required for the particular customized MCM expander application. The number of ports and wide ports required for a particular application are determined in accordance with performance and other criteria of the application well known to those of ordinary skill in the art. The determination may be performed in accordance with automated computational methods or as a matter of design choice by a human design engineer.

Element 402 is next operable to dispose a suitable set of standard expander components on the MCM design. The particular number of standard expander components will be determined substantially in accordance with the number and types of ports required for the application as determined above. As noted above, standard expander components may be provided having various standard numbers of ports or may be provided having a uniform standard number of ports. In both cases, a suitable set of standard expander components may be selected to provide the desired number of ports (both internal and external). Further, as noted above, the number of internal ports (n) and the number of external ports (m) may be determined independently of one another. Therefore, standard expander components may be selected having different numbers of internal and external ports to permit flexible design and fabrication of any desired configuration of internal and external ports. It need not be the case that all internal or external ports will be configured or enabled for use or need be matched with external ports on a one-for-one basis.

Element 404 next disposes an internal fabric component on the MCM expander design. As noted above, the internal fabric may be statically configured as wires or conductors specifically laid out on the MCM expander to couple appropriate internal ports to other internal ports. In addition, the internal fabric may be a dynamically configured switching structure to be configured upon reset of the MCM expander or dynamically configured in response to configuration parameters supplied from a SAS device coupled to an external port of the MCM expander.

Element 406 next determines whether the routes or paths within the internal fabric are intended to be static or dynamic. If intended for dynamic configuration, element 408 next disposes a programmable logic element on the MCM design to permit programming of the switchable internal fabric component disposed on the MCM design by processing of element 404. With the MCM design thus completed, processing continues at element 416 to fabricate the MCM design.

If element 406 determines that the routes within the internal fabric are intended to be static, element 410 next determines whether the static configuration is to be set at manufacture of the MCM expander or determined at reset of the MCM expander. If the static configuration is to be set a time of manufacture, element 412 is then operable to configure the internal fabric for the desired internal port coupling. If the static configuration is to be configured at reset of the MCM expander, element 414 is operable to dispose reset control logic on the MCM design coupled to the internal fabric to provide for configuration of static route configuration information in the switchable internal fabric upon reset of the MCM expander. In both cases, design of the MCM expander is completed and the method continues with step 416 to fabricate the completed MCM expander design.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

1. A multi-chip module (MCM) comprising:
a plurality of SAS expander component circuits each having a number (n) of internal ports internal to the MCM and each having a number (m) of external ports for coupling to SAS devices external to the MCM; and
an internal fabric coupling selected ones of the internal ports in selected ones of the plurality of SAS expander component circuits.

2. The module of claim 1 wherein the plurality of SAS expanders comprises a number (N) of SAS expander components each having a number (n_{N}) of internal ports.

3. The module of claim 1 wherein the plurality of SAS expanders comprises a number (N) of SAS expander components each having a number (m_{N}) of external ports.

4. The module of claim 1 wherein the internal fabric comprises a static fabric.

5. The module of claim 4 wherein the static fabric is configured at manufacture of the MCM.

6. The module of claim 4 wherein the static fabric is configured at reset of the MCM.

7. The module of claim 6 further comprising:
a control logic circuit to configure the static fabric at reset of the MCM.

8. The module of claim 1 wherein the internal fabric comprises a programmable fabric.

9. The module of claim 8 wherein the programmable fabric is adapted to be configured by information received from a SAS device coupled to an external port of a SAS expander of the MCM.

10. The module of claim 1 further comprising:
coordination logic communicatively coupled to the plurality of SAS expander component circuits to coordinate operation of the plurality of SAS expander component circuits.

11. The module of claim 10 wherein the coordination logic is adapted to present a unified expander to devices outside the module.

12. The module of claim 11 wherein the coordination logic is adapted to coordinate SMP message processing logic within each expander of the plurality of SAS expander component circuits.

13. The module of claim 111 wherein the coordination logic is adapted to present a single SAS address for the plurality of SAS expander component circuits.

14. The module of claim 11 wherein the coordination logic is adapted to present a single set of PHY numbers for the PHYs of the plurality of SAS expander component circuits.

15. A method for manufacturing a customized SAS expander having a predetermined number of ports, the method comprising:
disposing a number (N) of SAS expander components on a multi-chip module (MCM) wherein each SAS expander component has a number (n) of internal ports internal to the MCM and wherein each SAS expander component has a number (m) of external ports for coupling to SAS devices external to the MCM and wherein the number N is sufficient to provide a total ports numbering (m_{N}+n_{N}) substantially equal to the predetermined number of ports;
disposing an internal fabric on the MCM; and
configuring the internal fabric to provide desired routes between the total ports.

16. The method of claim 15 wherein the step of configuring further comprises: configuring the internal fabric as a static fabric at time of manufacture of the MCM.

17. The method of claim 15 further comprising:
disposing a control logic circuit on the MCM coupled to the internal fabric,
wherein the step of configuring further comprises:
applying signals from a control logic circuit to the internal fabric to configure the internal fabric as a static fabric at reset of the MCM.

18. The method of claim 15 further comprising:
disposing a coordination logic circuit on the MCM communicatively coupled to the SAS expander components to coordinate operation of the plurality of SAS expander components to present a unified expander interface to devices external to the MCM.
